(19) United States
(12) Patent Application Publication
(10) Pub. No.: US 2014/0162667 A1
(43) Pub. Date: Jun. 12, 2014

(54) RADIO RESOURCE DISTRIBUTION DEVICES, AND METHODS FOR CONTROLLING A RADIO RESOURCE DISTRIBUTION DEVICE

(71) Applicant: Markus Mueck, Unterhaching (DE)

(72) Inventor: Markus Mueck, Unterhaching (DE)

(21) Appl. No.: 13/707,692

(22) Filed: Dec. 7, 2012

(51) Int. Cl. H04W 72/04

(52) U.S. Cl. CPC H04W 72/04
USPC 455/450

(57) ABSTRACT

A radio resource distribution device may be provided. The radio resource distribution device may include: a communication condition determination circuit configured to determine a condition under which a radio communication device is to perform communication with a radio communication network; an availability determination circuit configured to determine at least one available radio resource out of a plurality of radio resources, that is available for the communication; and a radio resource determination circuit configured to determine a radio resource for the communication out of the at least one available radio resource based on the determined condition; wherein the plurality of radio resources includes: at least one first radio resource assigned to an operator of the radio communication network; and at least one second radio resource assigned to a holder of the second radio resource, and assigned by the holder of the second radio resource to the operator of the radio communication network.

### TECHNICAL FIELD

Aspects of this disclosure relate generally to radio resource distribution devices and methods for controlling a radio resource distribution device.

### BACKGROUND

Radio resources in radio communication networks may be limited. Furthermore, it may be expected that no more (or at least very few) dedicated spectrum will be available for cellular operators for mobile communications in the future. So devices and methods which may make good use of all resources may be desired.

### SUMMARY

A radio resource distribution device may be provided. The radio resource distribution device may include: a communication condition determination circuit configured to determine a condition under which a radio communication device is to perform communication with a radio communication network; an availability determination circuit configured to determine at least one available radio resource out of a plurality of radio resources, that is available for the communication; and a radio resource determination circuit configured to determine a radio resource for the communication out of the at least one available radio resource based on the determined condition; wherein the plurality of radio resources includes: at least one first radio resource assigned (for example by a regulatory authority) to an operator of the radio communication network; and at least one second radio resource assigned (for example by the regulatory authority) to a holder of the second radio resource, and assigned by the holder of the second radio resource to the operator of the radio communication network.

A method for controlling a radio resource distribution device may be provided. The methods may include: determining a condition under which a radio communication device is to perform communication with a radio communication network; determining at least one available radio resource out of a plurality of radio resources, that is available for the communication; and determining a radio resource for the communication from the at least one available radio resource based on the determined condition; wherein the plurality of radio resources includes: at least one first radio resource assigned (for example by a regulatory authority) to an operator of the radio communication network; and at least one second radio resource assigned (for example by the regulatory authority) to a holder of the second radio resource, and assigned by the holder of the second radio resource to the operator of the radio communication network.

A radio resource distribution device may be provided. The radio resource distribution device may include: a radio resource determination circuit configured to determine whether a radio communication device is to communicate with a radio communication network on a first frequency band or on a second frequency band, wherein the first frequency band is assigned (for example by a regulatory authority) to an operator of the radio communication network, and wherein the second frequency band is assigned (for example by the regulatory authority) to a holder of the second radio resource, and assigned by the holder of the second radio resources to the operator of the radio communication network.

A method for controlling a radio resource distribution device may be provided. The method may include: determining whether a radio communication device is to communicate with a radio communication network on a first frequency band or on a second frequency band, wherein the first frequency band is assigned (for example by a regulatory authority) to an operator of the radio communication network, and wherein the second frequency band is assigned (for example by the regulatory authority) to a holder of the second radio resource, and assigned by the holder of the second radio resources to the operator of the radio communication network.

### BRIEF DESCRIPTION OF THE DRAWINGS

In the drawings, like reference characters generally refer to the same parts throughout the different views. The drawings are not necessarily to scale, emphasis instead generally being placed upon illustrating the principles of various aspects of this disclosure. In the following description, various aspects of this disclosure are described with reference to the following drawings, in which:

FIG. 1 shows a communication system with first radio resources and second radio resources;

FIG. 2 shows a communication system with macro cells and small cells;

FIG. 3 shows a communication system with macro cells and small cells and with first radio resources and second radio resources;

FIG. 4 shows a diagram illustrating the role of a communication resources distribution device;

FIG. 5 shows a radio resource distribution device with a communication conditions determination circuit, an availability determination circuit, and a radio resource determination circuit;

FIG. 6 shows a radio resource distribution device with a conditions change determination circuit and a radio resource assignment circuit;

FIG. 7 shows a flow diagram illustrating a method for controlling a radio resource distribution device (for example the radio resource distribution device of FIG. 5 or FIG. 6);

FIG. 8 shows a radio resource distribution device with a radio resource determination circuit; and

FIG. 9 shows a flow diagram illustrating a method for controlling a radio resource distribution device (for example the radio resource distribution device of FIG. 8).

### DESCRIPTION

The following detailed description refers to the accompanying drawings that show, by way of illustration, specific details and aspects of the disclosure in which the invention may be practiced. Other aspects of the disclosure may be utilized and structural, logical, and electrical changes may be made without departing from the scope of the invention. The various aspects of the disclosure are not necessarily mutually exclusive, as some aspects of the disclosure may be combined with one or more other aspects of the disclosure to form new aspects of the disclosure.

The terms “coupling” or “connection” are intended to include a direct “coupling” or direct “connection” as well as an indirect “coupling” or indirect “connection”, respectively.

The word “exemplary” is used herein to mean “serving as an example, instance, or illustration”. Any aspect of this disclosure or design described herein as “exemplary” is not necessarily to be construed as preferred or advantageous over other aspect of this disclosure or designs.

The term “protocol” is intended to include any piece of software, that is provided to implement part of any layer of the communication definition.

A radio communication device may be an end-user mobile device (MD). A radio communication device may be any kind of radio communication terminal, mobile radio communication device, mobile telephone, personal digital assistant, mobile computer, or any other mobile device configured for communication with another radio communication device, a mobile communication base station (BS) or an access point (AP) and may be also referred to as a User Equipment (UE), a mobile station (MS) or an advanced mobile station (advanced MS, AMS), for example in accordance with IEEE 802.16m.

A base station, for example a radio base station, may be a radio base station operated by a network operator, e.g. a NodeB or an eNodeB, and may provide a macro cell, or may be a home base station (which may provide a small cell), e.g. a Home NodeB, e.g. a Home (e)NodeB. In an example, a ‘Home NodeB’ may be understood in accordance with 3GPP (Third Generation Partnership Project) as a trimmed-down version of a cellular mobile radio base station optimized for use in residential or corporate environments (e.g., private homes, public restaurants or small office areas). Femto-Cell Base Stations (FC-BS) may be provided in accordance with a 3GPP standard, but may also be provided for any other mobile radio communication standard, for example for IEEE 802.16m. However, even for a FC-BS, the operator of the mobile radio communication network, to which the FC-BS belongs, may control the assignment of radio resources.

As described herein, first radio resources and second radio resources may be different in the ownership of the radio resource. For example, the first radio resources may be assigned to an operator of a radio communication network, and the second radio resources may be assigned to a holder of the second radio resource, and may be assigned or lent (or rented) to the operator of the radio communication network. It will be understood that assignment of radio resources may be performed by a regulatory authority. It will be understood that the operator of the radio communication network and the holder of the second radio resources are different. For example, the operator of the radio communication network may use the first radio resources and may be the owner of the radio resource. Furthermore, the operator of the radio communication network may use the second radio resource, and the holder of the second radio resources may be the owner of the second radio resource.

The first radio resources may be referred to as a dedicated radio resource. The second radio resources may be referred to as a shared (or a common) radio resource. The first radio resources may be dedicated to the operator of the base station (or cell). The second radio resources may be shared between the operator and one or more other (primary or secondary) operators.

The same spectrum of the second radio resources may be used by other (for example a primary or secondary) network operators at other times. These other times may be separated by seconds or by months. It will be understood that the act of sharing may mean that the spectrum may be temporarily allocated to one operator and may be revoked or may be automatically de-allocated after the allocation time runs out or when another operator is (re)-allocated the spectrum.

The same spectrum of the second radio resources may be used by other (for example a primary or secondary) network operators at other locations. These other locations may be separated by meters, kilometers or by regions like cities or geographical areas. It will be understood that the act of sharing may mean that the spectrum may be allocated to one operator at a given or pre-defined location and may not be allocated to that operator at other locations or may be de-allocated when another operator is (re)-allocated the spectrum at the given or pre-defined location.

It will be understood that the act of sharing may comprise a combination of the principles described above. The spectrum may be allocated to one operator temporarily at a given or pre-defined location whereas the same spectrum is allocated to one or more other operators at other times and/or another location.

For example, the first radio resources may be allocated statically (for example for a long period of time) to the operator (for example to a fixed operator). For example, the second radio resources may be allocated temporarily (for example dynamically) to the operator. For example, the second radio resources may be assigned to a primary holder, but another operator may use it. For example, the first radio resources may be allocated to the operator for a first period of time, and the second radio resources may be allocated to the operator for a second period of time, wherein the first period of time may be longer than the second period of time.

It will be understood that the first radio resources may include one or more frequency bands. It will be understood that the second radio resources may include one or more frequency bands. The second radio resources may include radio resources assigned to different holders, and lent to the operator of the radio communication system.

A regulatory authority may be understood as a public authority or a government authority, which may assign radio resources to respective holders of the radio resources, or may be a quasi-private authority that is given the authorization by a public or governmental authority (for example a broker, for example a spectrum broker, for example a cloud spectrum broker).

The radio resource distribution device may include a memory which may for example be used in the processing carried out by the radio resource distribution device. The radio communication device may include a memory which may for example be used in the processing carried out by the radio communication device. A memory may be a volatile memory, for example a DRAM (Dynamic Random Access Memory) or a non-volatile memory, for example a PROM (Programmable Read Only Memory), an EPROM (Erasable PROM), EEPROM (Electrically Erasable PROM), or a flash memory, for example, a floating gate memory, a charge trapping memory, an MRAM (Magnetoresistive Random Access Memory) or a PCRAM (Phase Change Random Access Memory).

The radio resource distribution device may be provided:
as a part of a mobile radio access network;
as a part of a mobile radio core network;
in a mobile radio core network sub-system;
of the mobile radio core network;
as a part of a base station, NodeB, eNodeB, Access Point;
as a part of a core network entity, e.g. a mobility anchor (MME, GSN); or
in a separate entity.

The radio resource distribution device may be shared between a plurality of radio access networks, and may distribute radio resources to a plurality of operators of the plurality of radio access networks.

As used herein, a “circuit” may be understood as any kind of a logic implementing entity, which may be special purpose circuitry or a processor executing software stored in a memory, firmware, or any combination thereof. Furthermore, a “circuit” may be a hard-wired logic circuit or a programmable logic circuit such as a programmable processor, for example a microprocessor (for example a Complex Instruction Set Computer (CISC) processor or a Reduced Instruction Set Computer (RISC) processor). A “circuit” may also be a processor executing software, for example any kind of computer program, for example a computer program using a virtual machine code such as for example Java. Any other kind of implementation of the respective functions which will be described in more detail below may also be understood as a “circuit”. It may also be understood that any two (or more) of the described circuits may be combined into one circuit. Furthermore it will be understood, that what is stated above for a circuit may hold true also for each of the entire devices described herein.

Description is provided for devices, and description is provided for methods. It will be understood that basic properties of the devices also hold for the methods and vice versa. Therefore, for sake of brevity, duplicate description of such properties may be omitted.

It will be understood that any property described herein for a specific device may also hold for any device described herein. It will be understood that any property described herein for a specific method may also hold for any method described herein.

Radio resources in radio communication networks may be limited. So devices and methods which may make good use of all resources may be desired.

Devices and methods may be provided in the context of LSA/ASA/CSS (Licensed Shared Access/Authorized Shared Access/Cloud Spectrum Services), like will be described below.

The LSA (Licensed Shared Access) concept was recently developed by RSPG (Radio Spectrum Policy Group) on an European level. The objective is to propose a new way for answering to the operators' needs for more spectrum. It may be expected that no more (or at least very few) dedicated spectrum will be available for cellular operators for mobile communications in the future. LSA proposes mechanisms for introducing shared spectrum based solutions, i.e. mobile cellular operators will be able to use spectrum on a shared basis.

LSA is based on a similar solution by Qualcomm and NOKIA which is called ASA (Authorized Shared Access). ASA, is limited to IMT (International Mobile Telecommunications) spectrum while LSA is also addressing non-IMT bands. Both exist on a rather conceptual level for the time being.

INTEL has introduced a related technology which is called CSS (Cloud Spectrum Services). It addresses the same framework as LSA and ASA, but introduces more detailed implementation solutions.

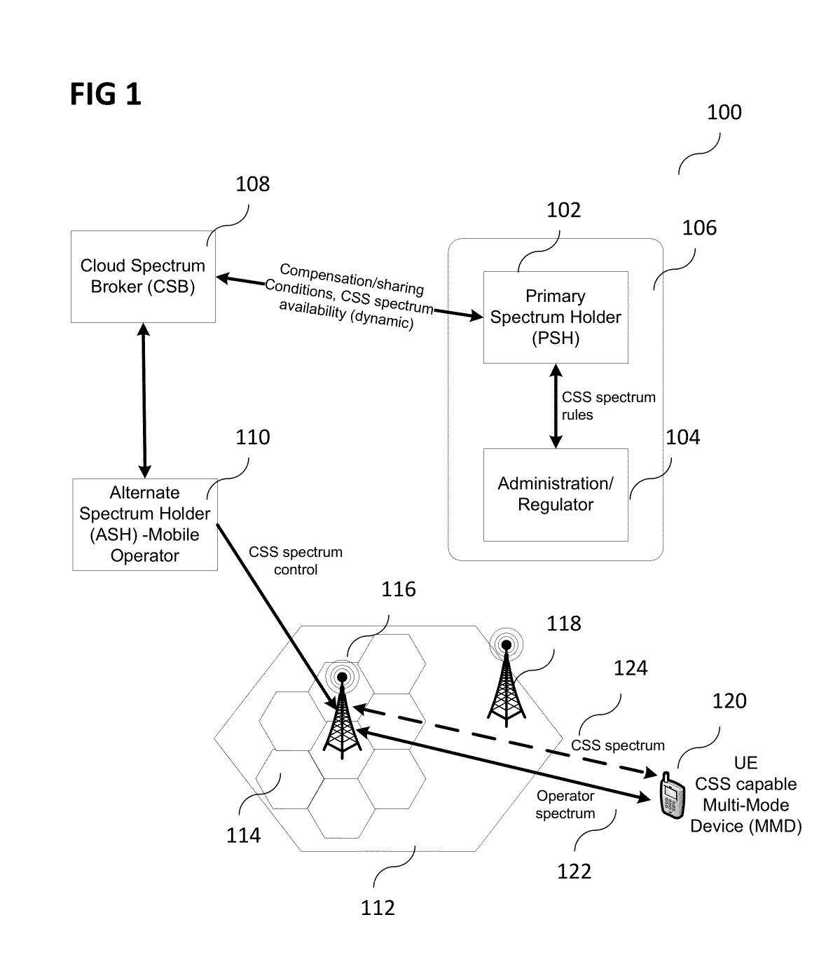

FIG. 1 shows a communication system 100 with dedicated radio resources and shared radio resources. In the communication system 100 (which may also be referred to as a CSS ecosystem including a cloud spectrum broker (CBS) 108), the CSB 108 may communicate with a primary spectrum holder (PSH) 102 to arrange for compensation and sharing conditions and may provide dynamic information on CSS spectrum availability. The PSH 102 may act in accordance with CSS spectrum rules in communication with an administration or a regulator 104. The PSH 102 and the regulator 104 together (like indicated by box 106) may form a provider of CSS spectrum. The CBS 108 may inform an alternate spectrum holder (ASH) 110, which may be a mobile operator, about the CSS conditions (for example the compensation conditions, the sharing conditions, and/or the CSS spectrum availability). A UE 120, which may be a CSS capable multi mode device (MMD), may desire to perform communication in a region 112, covered by a plurality of cells (wherein one of them is exemplarily shown as a cell 114) provided by a plurality of base stations (wherein two of them are exemplarily shown as a base station 116 and a base station 118). For example the UE 120 may desire to communicate with the base station 116. The UE 120 may for example use an operator spectrum (in other words: first radio resources), like indicated by a bold arrow 122, and may instead or in addition use a CSS spectrum (in other words: second radio resources), like indicated by a dashed arrow 124.

Devices and methods may be provided in the context of small cells. A small cell may for example be a Femto cell, a Pico cell, a Nano Cells, a Home BS, a Home NB, or a Home e NB.

An objective of LSA/ASA/CSS as briefly described above relates to providing more resource (and thus throughput or QoS in general) to mobile cellular user devices. The LSA/ASA/CSS concept may grant access to more spectrum (beyond the operator owned dedicated bands) through a shared spectrum approach. For example, the spectrum may be used on a secondary basis by the concerned operators and users.

Another way for achieving higher throughput may be based on so-called “Small Cells”. Small cells (or smaller cells; wherein small and smaller may be understood as compared to commonly used macro cells) may be provided, so that there may be less users per cell and the available spectrum may be shared among a smaller number of users. In consequence, the available resources per user may rise. A denser infrastructure network compared to existing macro-cell networks may be provided.

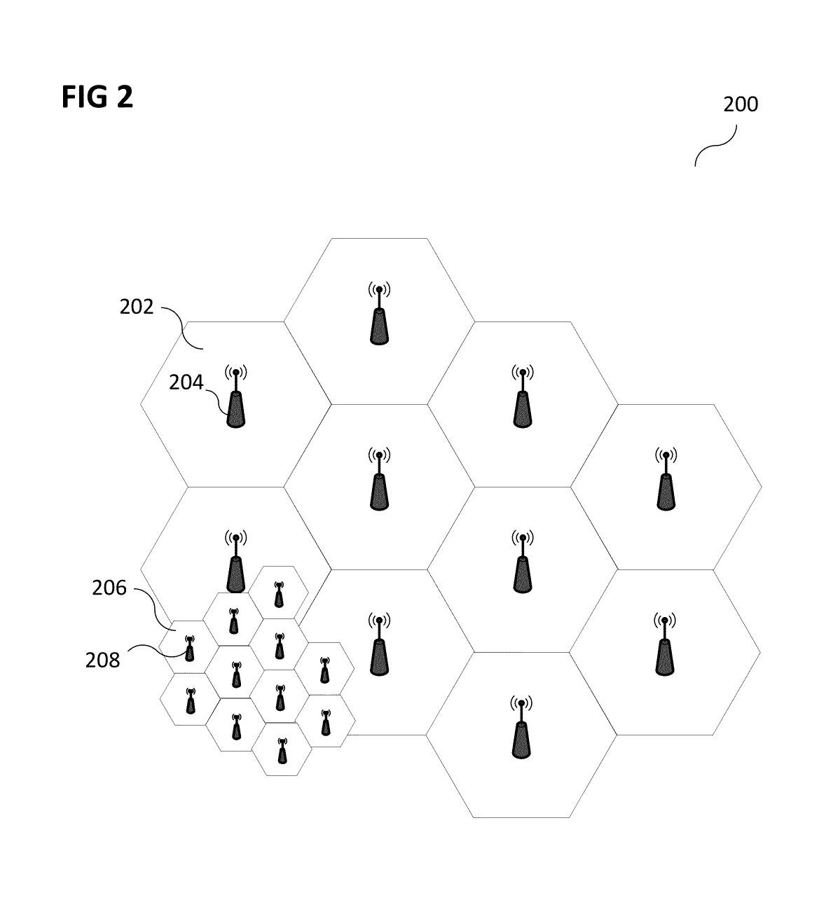

FIG. 2 shows a communication system 200 with macro cells and small cells. A plurality of macro cells (which may be illustratively shown as bigger hexagons in FIG. 2, one of which is exemplarily referred to as macro cell 202) may be provided. Each macro cell may for example be provided by a macro base station (which may also be referred to as macro cell base station). For example the macro cell 202 may be provided by macro base station 204. A plurality of small cells (which may be illustratively shown as smaller hexagons in FIG. 2, one of which is exemplarily referred to as small cell 206) may be provided. Each small cell may for example be provided by a small base station (which may also be referred to as small cell base station). For example the small cell 206 may be provided by small base station 208.

The upper two approaches—LSA/ASA/CSS and Small Cells—may be considered independently. Companies may be considering only one of both solutions and optimize the ecosystem for its needs. Both LSA/ASA/CSS and Small Cells serve the same objective of providing more resources to concerned users. Since both approaches are fundamentally different, there are different advantages and drawbacks.

Devices and methods may be provided to introduce a “Communication Resources Distribution Entity in the context of LSA (Licensed Share Access) and Small Cells”, which may also be referred to as radio resource distribution device. In case, the operator has both systems deployed, the best solution for providing the users with more resources may be selected according to the various methods and devices provided.

Devices and methods may be provided which introduce a novel Communication Resources Distribution Entity in the context of LSA (Licensed Share Access)/ASA (Authorized Shared Access)/CSS (Cloud Spectrum Services) and Small Cells.

LSA/ASA/CSS and Small Cells based system deployments may be considered independently according to commonly used systems. For example, industry may either focus on one single approach (either LSA/ASA/CSS or Small Cells) and may optimize the entire ecosystems for the usage of one single concept. A combined usage of LSA/ASA/CSS and Small Cells is not known at the current point in time.

Since both LSA/ASA/CSS and Small Cells are very different solutions to the problem of how to get more communication resources to be allocated to a given user, there may be very different advantages and drawbacks. Choosing only one of those two approaches may force operators to accept the disadvantages of the concerned approach (LSA/ASA/CSS or Small Cells). Devices and methods may be provided as described herein which may help to avoid this problem, since a novel entity (or device) is introduced (“Communication Resources Distribution Entity”, which may also be referred to as radio resource distribution device) which may ensure that the best approach is selected for the specific context of the concerned user.

In a commonly used approach, the operators/users typically must accept the following drawbacks, depending on the final choice of a single approach (LSA/ASA/CSS or Small Cells) that is adopted.

Drawbacks of a fully LSA/ASA/CSS based approach may include, among others:

a) The shared spectrum may be used on a secondary basis, i.e. an operator/user may not be guaranteed to have continued access to the spectrum for a long period of time. This fact may make cell planning and guaranteed QoS (Quality of Service) provisioning very difficult for operators.

b) The available spectrum may be expected to vary over time, depending on the needs of the primary spectrum holder. For example, depending on the specific point in time, the user may have access to spectrum located at very different carrier frequencies, for example ranging from 470 MHz (TV WS) up to 6 GHz and beyond. In this broad spectrum scope, the propagation characteristics may be varying. At low carrier frequencies, a single transmitter may cover a large area while at higher frequencies the opposite may be the case. Since the spectrum usage conditions may be typically changing over time, cell planning and interference management may become difficult and costly for operators.

Drawbacks of a fully Small Cells based approach may include, among others:

a) A Small Cells ecosystem may require the deployment of a large number of Base Stations (Small Cell Base Stations) which may be very costly for an operator. Furthermore, it may be a challenge to find suitable geographic locations where small cells can be set up and operated.

b) Small Cells may typically be small in size. For example, a user with a challenging mobility profile (for example a user moving at high speed, for example in a train or a car or an airplane) may prefer larger cells such that frequent handovers are avoided.

In a target network context (for example in a network in which the various methods and devices provided may be applied), operators may be expected to operate (everywhere or in specific locations) small cells and/or macro cells. Both types of cells may often be overlapping, such that a user can either be attached to a macro base station or a small cell base station (or both)—depending on the needs and the user context. Also, the operator may be expected to allocate dedicated spectrum (for example operator owned) and (if locally and temporally available) shared spectrum to concerned user devices. When shared spectrum is used, the operator may act as a secondary user with the primary spectrum holder still being the highest-priority user of the spectrum.

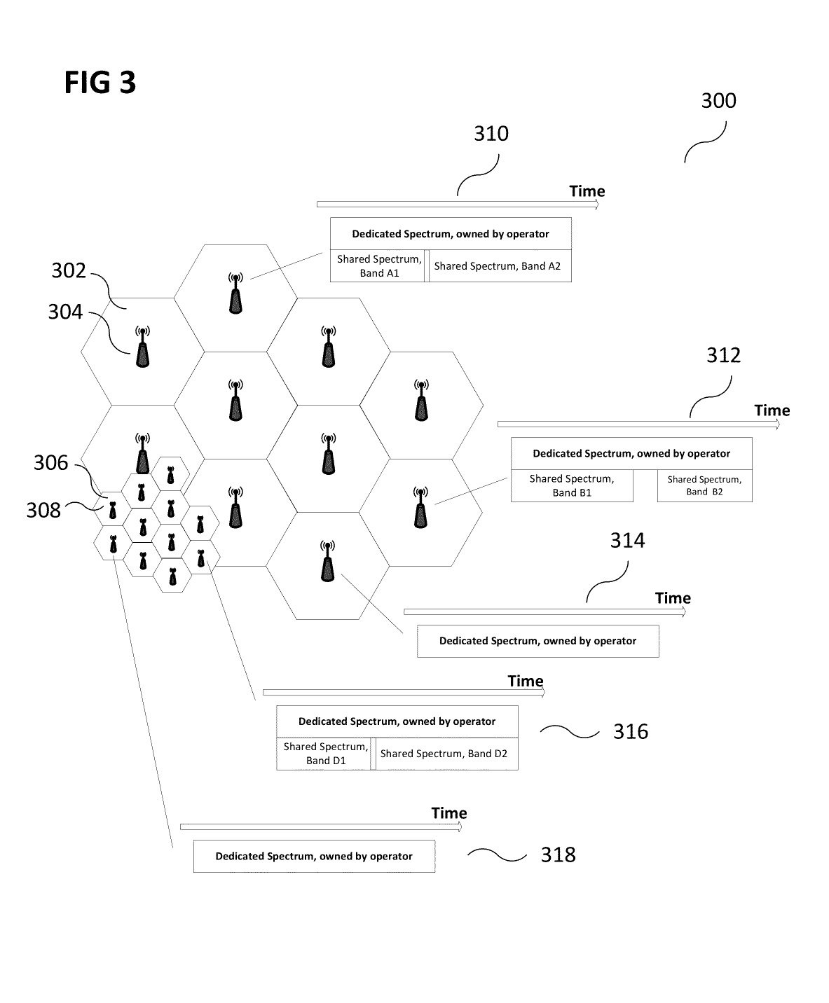

FIG. 3 shows a communication system 300 with macro cells (wherein one exemplary macro cell 302 provided by a macro (cell) base station 304 is shown) and small cells (wherein one exemplary small cell 306 provided by a small (cell) base station 308 is shown) and with dedicated radio resources and shared radio resources. In the communication system 300, a combination of macro cells/small cells and LSA/ASA/CSS may be provided. Some BS (base stations) may have only access to dedicated spectrum (for example operator owned), and some may have also (or only) access to shared spectrum (which may be used on a secondary basis).

Some Base Stations (Macro Base Stations and/or Small Cells Base Stations) may either access to dedicated (for example operator owned) spectrum only or to both, dedicated spectrum and shared spectrum (for example based on LSA/ASA/CSS). The allocation of dedicated spectrum may be expected to be static, while shared spectrum may be expected to be dynamically allocated over time and geographic location. Its allocation may thus be time dependent.

Devices and methods may be provided according to which mobile devices (for example radio communication devices) interact with a radio resource distribution device (which may also be referred to “Communication Resources Distribution Entity”). The radio resource distribution device may decide which type of connection will be granted to the user:
Macro Cell link using dedicated operator spectrum (like indicated in sub-figure 314),
Macro Cell link using dynamically allocated shared spectrum,
Macro Cell link using dynamically allocated shared spectrum and dedicated operator spectrum simultaneously, for example through corresponding Carrier Aggregation of both types of bands (like indicated in sub-figures 310 and 314),
Small Cell link using dedicated operator spectrum (like indicated in sub-figure 318),
Small Cell link using dynamically allocated shared spectrum,
Small Cell link using dynamically allocated shared spectrum and dedicated operator spectrum simultaneously, for example through corresponding Carrier Aggregation of both types of bands (like indicated in sub-figure 316),
Combination of Macro Cell and Small Cell link through carrier aggregation of at least two bands allocated to Macro/Small Cells. For both bands, dedicated operator spectrum or dynamically allocated shared spectrum may be used.

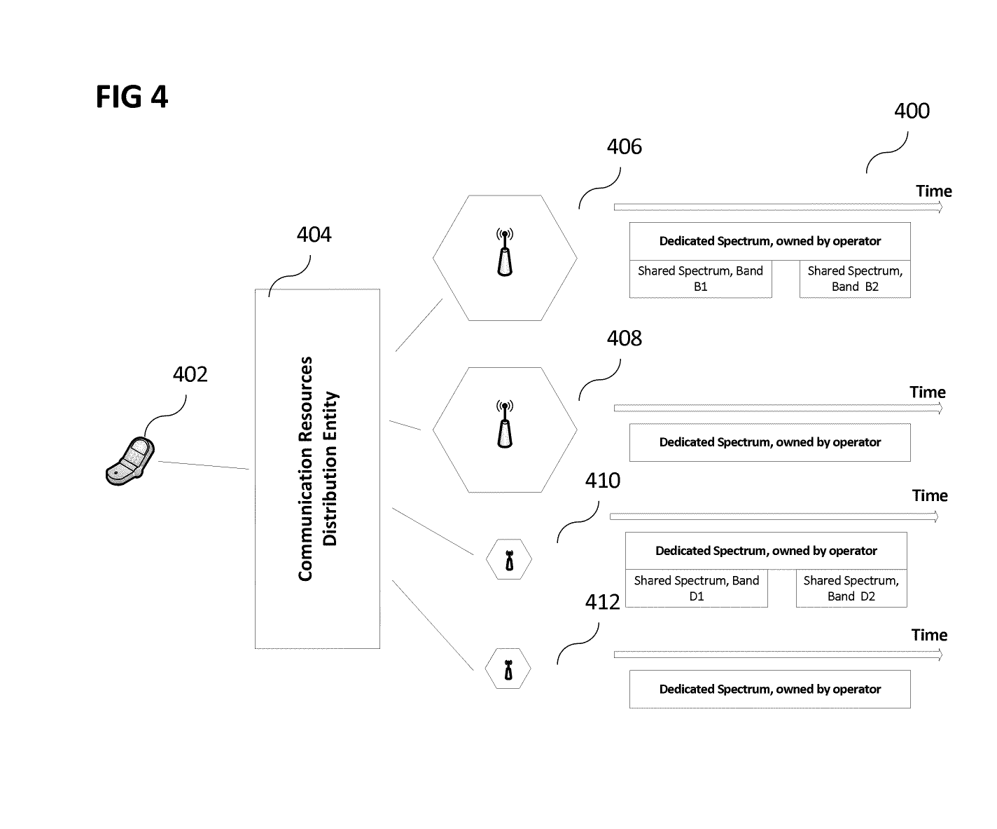

FIG. 4 shows a diagram 400 illustrating the role of a radio resources distribution device (for example of the “Communication Resources Distribution Entity”). In FIG. 4, interaction of user devices with a “Communication Resources Distribution Entity” is illustrated, wherein the “Communication Resources Distribution Entity” may decide on the final link solution by picking one of the above mentioned possible configurations. A radio communication device 402 may interact with the radio resource distribution device (for example of the “Communication Resources Distribution Entity”) 404. For example, as indicated by sub-figure 406, the radio resource distribution device 404 may assign a dedicated spectrum, owned by an operator to the radio communication device 402, and this assignation may persist, even while shared spectrum assigned to the radio communication device may change. The assignments according to sub-figure 406 may apply for a macro cell. For example, as indicated by sub-figure 408, the radio resource distribution device 404 may assign a dedicated spectrum, owned by an operator to the radio communication device 402, only. The assignments according to sub-figure 408 may apply for a macro cell. For example, as indicated by sub-figure 410, the radio resource distribution device 404 may assign a dedicated spectrum, owned by an operator to the radio communication device 402, and this assignation may persist, even while shared spectrum assigned to the radio communication device may change. The assignments according to sub-figure 410 may apply for a small cell. For example, as indicated by sub-figure 412, the radio resource distribution device 404 may assign a dedicated spectrum, owned by an operator to the radio communication device 402, only. The assignments according to sub-figure 412 may apply for a small cell.

In the following, a basic mechanism of various devices and methods provided will be described.

i) A Mobile Device may establish a first link with the network, for example using a macro cell base station and using dedicated spectrum.

ii) A Mobile Device may be communicating context information to the “Communication Resources Distribution Entity”, wherein the “Communication Resources Distribution Entity” may for example be defined by an IP Address or specific interfaces introduced by the concerned operator. This context information may include indications on

a) the user's mobility context, for example information on whether the mobile device is rather static, whether it is used in a nomadic mobility context, whether it is moving at pedestrian speed, or whether it is moving at high speed; For example, the (macro) BS or the Core Network (for example a Mobility Anchor) may know about user's mobility context due to cell changes of the recent past. Then the Mobile Device may communicate a context that includes an ID (identifier) of the device, user or connection and the Communication Resources Distribution Entity (CRDE) may use stored context or may request a further context from another BS, a network entity or a data base.

b) the User's QoS (quality of service) requirement, for example information on which type of applications is the user typically using. For example, video streaming may desire high data-rates and may not tolerate lengthy stream interruptions. For example, VoIP (voice over IP) may require low latency; for example, the information may be provided may the mobile device or may be derived from session or application layer entities in the (operator's) network.

c) the supported features of the user's mobile device, for example information on which bands may be supported for shared spectrum usage, and/or information on whether carrier aggregation is possible for mixing dedicated spectrum and shared spectrum. This information may come from the mobile device, but it may have been transmitted to another BS before and may be transferred to the CRDE.

iii) Based on the context information of the concerned mobile device and taking information on other mobile devices into account, the “Communication Resources Distribution Entity” may decide which type of connection will be granted to a Mobile Device.

iv) In case that the context of the concerned Mobile Device changes, the “Communication Resources Distribution Entity” may be contacted again by the concerned mobile device and the previous decision on the type of connection to be granted may be possibly changed.

Based at least on the context information above a “combined decision” or “joint decision” may be made on
allocating frequencies of certain nature or type (dedicated vs. dynamic/shared),
in certain regions (high vs. low frequencies with respective signal propagation),
via certain cell size (small vs. macro) and specific cell (to serve the very location of the device).

Various devices and methods may be provided for jointly deciding on several possible dimensions, for example
the cell size AND
the frequency range/bands AND
the fact whether dedicated (operator owned) or shared (leased by the operator) spectrum is used.

By deciding several of these dimensions jointly, the resources finally used by the device and the resource allocation within the operator's network may be adapted much better to the demand of the device while increasing efficiency of the whole network.

When jointly deciding on the possible dimensions as described above, a better resource distribution may be achieved.

For example, the allocation of resources may be based on the following principles

a) In case that both dedicated spectrum and shared spectrum is available in a similar frequency band, allocate preferably dedicated spectrum, since shared spectrum allocation will require an overhead in terms of for example signaling and/or mobile device reconfiguration. Communication based on dedicated spectrum may be expected to be (slightly) more efficient compared to shared spectrum usage.

b) Allocate shared spectrum in case that i) there is not enough dedicated spectrum and/or ii) the (propagation) characteristics of the shared spectrum are superior, e.g. shared spectrum is available at a low carrier frequency range such that mobile users can be covered with a reduced numbers of handovers being required (due to the lower propagation attenuation at a low frequency range).

c) Allocate static users to small cells and use preferably dedicated spectrum. Use shared spectrum if not enough dedicated spectrum is available.

d) Allocate low- to medium-mobility users to small cells and use preferably shared spectrum if the (propagation) characteristics are superior or dedicated spectrum is not sufficient, otherwise use dedicated spectrum.

e) Allocate medium- to high-mobility users to macro cells and use preferably shared spectrum if the (propagation) characteristics are superior or dedicated spectrum is not sufficient, otherwise use dedicated spectrum.

f) Combine both dedicated spectrum and shared spectrum if a concerned user has high bandwidth requirements which cannot be fully met by dedicated spectrum. A combination of both types of spectrum may for example be achieved through suitable carrier aggregation.

g) In case that too much dedicated spectrum has been allocated to previously attaching users and a large number of new users is currently coming in, the previous allocation of dedicated spectrum may be changed. For example, some users may be partly moved to shared spectrum (for example by carrier aggregation of dedicated spectrum and shared spectrum bands) or even fully moved to shared spectrum.

h) In case that a user context changes (for example the mobility profile changes or the user changes his/her applications and thus requires a different QoS), the “Communication Resources Distribution Entity” may be contacted and a change of the configuration can be requested by the concerned user devices. Alternatively, the “Communication Resources Distribution Entity” may automatically detect such a context change and autonomously may reconsider the chosen configuration.

It will be understood that the cases as described under items a) to h) above are only examples and the decision may be dependent on various additional factor like for example price of spectrum and the decision may follow different routes than described above even with the same input parameters.

FIG. 5 shows a radio resource distribution device 500. The radio resource distribution device 500 may include a communication condition determination circuit 502 configured to determine a condition under which a radio communication device is to perform communication with a radio communication network. The radio resource distribution device 500 may further include an availability determination circuit 504 configured to determine at least one available radio resource out of a plurality of radio resources, that is available for the communication. The radio resource distribution device 500 may further include a radio resource determination circuit 506 configured to determine a radio resource for the communication out of the at least one available radio resource based on the determined condition. The plurality of radio resources may include or may be: at least one first radio resource assigned (for example by a regulatory authority) to an operator of the radio communication network; and at least one second radio resource assigned (for example by the regulatory authority) to a holder of the second radio resource, and assigned by the holder of the second radio resource to the operator of the radio communication network. The communication condition determination circuit 502, the availability determination circuit 504, and the radio resource determination circuit 506 may be coupled with each other, for example via a connection 508, for example an optical connection or an electrical connection, such as for example a cable or a computer bus or via any other suitable electrical connection to exchange electrical signals.

The plurality of radio resources may include or may be: a radio resource of a macro base station on the first radio resource; a radio resource of a macro base station on the second radio resource; a radio resource of a small base station on the first radio resource; and a radio resource of a small base station on the second radio resource.

The condition determination circuit 502 may determine the condition based on a velocity of the radio communication device and/or a network mobility activity of the device experienced in the (recent) past (for example in a pre-determined period, for example in the previous minute, or in the previous hour) and/or a desired quality of service of the communication and/or a desired bandwidth of the communication and/or a subscriber plan for the radio communication device and/or at least one communication capability of the radio communication device. It will be understood that the velocity may be a virtual velocity.

The availability determination circuit 504 may determine the radio resource based on a location of the radio communication device and/or a network load and/or a communication load on at least one of the plurality of radio resources and/or a communication load on the radio resources of the macro base stations and/or a communication quality characteristic of at least one of the plurality of radio resources and/or a subscriber plan for the radio communication device.

The macro base station may include or may be a base station with a coverage area larger than a coverage area of a small base station.

The at least one first radio resource may include or may be a radio resource used only by the operator of the communication network.

The at least one second radio resource may include or may be a radio resource shared by the operator of the communication network and the holder of the radio resource.

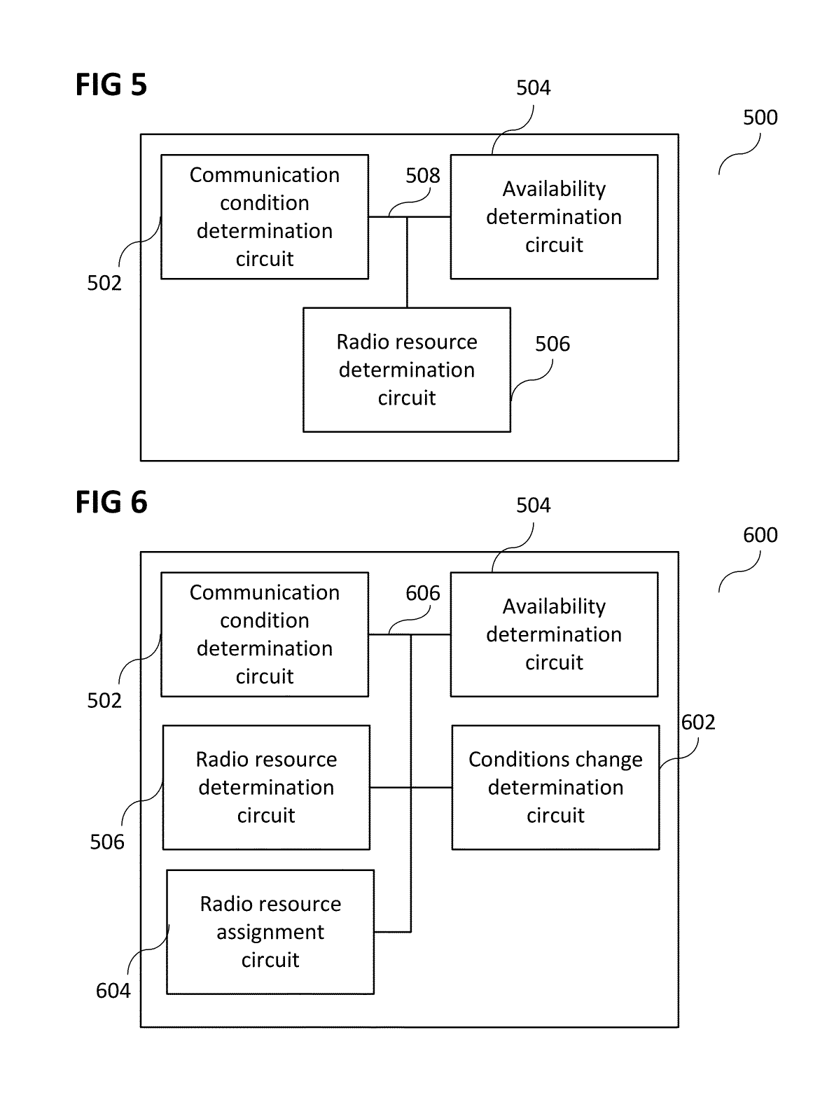

FIG. 6 shows a radio resource distribution device 600. The radio resource distribution device 600 may, similar to the radio resource distribution device 500 of FIG. 5, include a communication condition determination circuit 502. The radio resource distribution device 600 may, similar to the radio resource distribution device 500 of FIG. 5, further include an availability determination circuit 504. The radio resource distribution device 600 may, similar to the radio resource distribution device 500 of FIG. 5, further include a radio resource determination circuit 506. The radio resource distribution device 600 may further include a conditions change determination circuit 602, like will be described below. The radio resource distribution device 600 may further include a radio resource assignment circuit 604, like will be described below. The communication condition determination circuit 502, the availability determination circuit 504, the radio resource determination circuit 506, the conditions change determination circuit 602, and the radio resource assignment circuit 604 may be coupled with each other, for example via a connection 606, for example an optical connection or an electrical connection, such as for example a cable or a computer bus or via any other suitable electrical connection to exchange electrical signals.

The condition change determination circuit 602 may determine whether the condition changes during an ongoing communication. The radio resource determination circuit 506 may determine whether to change the radio resource for the communication based on whether the condition changes.

The radio resource assignment circuit 604 may transmit an indication of the radio resource for the communication to at least one of the radio communication device and to a base station which is configured to provide communication using the radio resource for the communication. This indication may be directly sent by the radio resource distribution device (which might be the rare case) or the radio resource distribution device may provide this indication to another entity which then would provide this information to the mobile device.

The radio resource determination circuit 506 may determine a radio resource on the at least one first radio resource if the availability determination circuit determines that both the at least one first radio resource and the at least one second radio resource are available for the communication.

The radio resource determination circuit 506 may determine a radio resource of a small base station if the radio communication device is in a condition of low velocity and/or low network mobility activity.

The radio resource determination circuit 506 may determine a plurality of radio resources for combined usage for the communication.

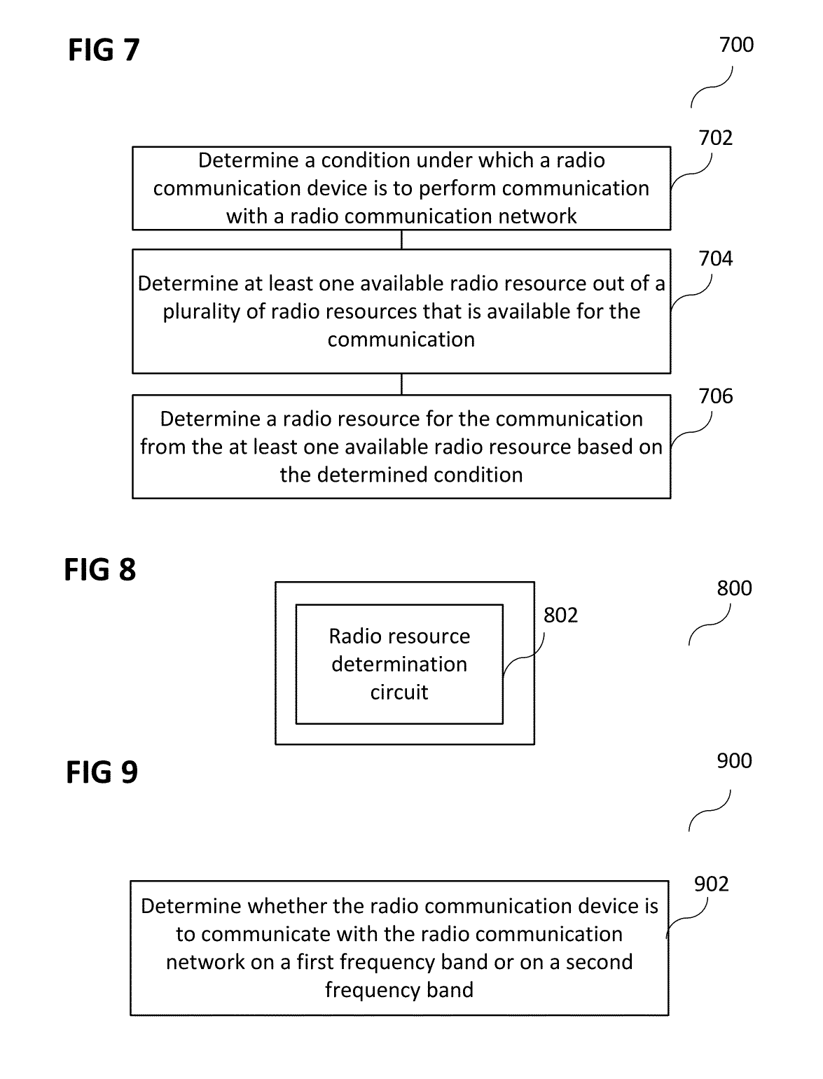

FIG. 7 shows a flow diagram 700 illustrating a method for controlling a radio resource distribution device. In 702, a communications condition determination circuit of the radio resource distribution device may determine a condition under which a radio communication device is to perform communication with a radio communication network. In 704, an availability determination circuit of the radio resource distribution device may determine at least one available radio resource out of a plurality of radio resources that available for the communication. In 706, a radio resource determination circuit of the radio resource distribution device may determine a radio resource for the communication from the at least one available radio resource based on the determined condition. The plurality of radio resources may include or may be: at least one first radio resource assigned (for example by a regulatory authority) to an operator of the radio communication network; and at least one second radio resource assigned (for example by the regulatory authority) to a holder of the second radio resource, and assigned by from the holder of the second radio resource to the operator of the radio communication network.

The plurality of radio resources may include or may be: a radio resource of a macro base station on the first radio resource; a radio resource of a macro base station on the second radio resource; a radio resource of a small base station on the first radio resource; and a radio resource of a small base station on the second radio resource.

The method may further include determining the condition based a velocity of the radio communication device and/or a network mobility activity of the device experienced in the (recent) past (for example in a pre-determined period, for example in the previous minute, or in the previous hour) and/or a desired quality of service of the communication and/or a desired bandwidth of the communication and/or a subscriber plan for the radio communication device and/or at least one communication capability of the radio communication device. It will be understood that the velocity may be a virtual velocity.

The method may further include determining the radio resource based on a location of the radio communication device and/or a network load and/or a communication load on at least one of the plurality of radio resources and/or a communication load on the radio resources of the macro base stations and/or a communication quality characteristic of at least one of the plurality of radio resources and/or a subscriber plan for the radio communication device.

A macro base station may include or may be a base station with a coverage area larger than a coverage area of a small base station.

The first radio resources may include or may be a radio resource used only by the operator of the communication network.

The second radio resources may include or may be a radio resource shared by the operator of the communication network and the holder of the radio resource.

The method may further include determining whether the condition changes during an ongoing communication and determining whether to change the radio resource for the communication based on whether the condition changes.

The method may further include transmitting an indication of the radio resource for the communication to at least one of the radio communication device and to a base station configured to provide communication using the radio resource for the communication. This indication may be directly sent by the radio resource distribution device (which might be the rare case) or the radio resource distribution device may provide this indication to another entity which then would provide this information to the mobile device.

The method may further include determining a radio resource on the at least one first radio resource if the availability determination circuit determines that both the at least one first radio resource and the at least one second radio resource are available for the communication.

The method may further include determining a radio resource of a small base station if the radio communication device is in a condition of low velocity.

The method may further include determining a plurality of radio resources for combined usage for the communication.

FIG. 8 shows a radio resource distribution device. The radio resource distribution device may include a radio resource determination circuit 802 configured to determine whether a radio communication device is to communicate with a radio communication network on a first frequency band or on a second frequency band. The first frequency band may be assigned (for example by a regulatory authority) to an operator of the radio communication network. The second frequency band may be assigned (for example by the regulatory authority) to a holder of the second frequency band, and may be assigned by the holder of the second frequency band to the operator of the radio communication network.

The radio resource determination circuit 802 may further determine whether the radio communication device is to communicate with a macro base station or a small base station.

FIG. 9 shows a flow diagram illustrating a method for controlling a radio resource distribution device. The method may include: determining whether a radio communication device is to communicate with a radio communication network on a first frequency band or on a second frequency band. The first frequency band may be assigned (for example by a regulatory authority) to an operator of the radio communication network. The second frequency band may be assigned (for example by the regulatory authority) to a holder of the second frequency band, and may be assigned by the holder of the second frequency band to the operator of the radio communication network.

The method may further include determining whether the radio communication device is to communicate with a macro base station or a small base station.

Any one of the radio communication devices or radio resource distribution devices described above may be configured according to a radio access technology in accordance with cellular mobile radio communication systems (which may also be referred to as Cellular Wide Area radio communication systems), metropolitan area mobile radio communication systems (which may also be referred to as Metropolitan Area System radio communication systems) and/or short range mobile radio communication systems (which may also be referred to as Short Range radio communication systems).

Any one of the radio communication devices or radio resource distribution devices described above may be configured according to at least one of the following radio access technologies: a Bluetooth radio communication technology, an Ultra Wide Band (UWB) radio communication technology, and/or a Wireless Local Area Network radio communication technology (for example according to an IEEE 802.11 (for example IEEE 802.11n) radio communication standard)), IrDA (Infrared Data Association), Z-Wave and ZigBee, HiperLAN/2 ((HIgh PErformance Radio LAN; an alternative ATM-like 5 GHz standardized technology), IEEE 802.11a (5 GHz), IEEE 802.11g (2.4 GHz), IEEE 802.11n, IEEE 802.11VHT (VHT=Very High Throughput), Worldwide Interoperability for Microwave Access (WiMax) (for example according to an IEEE 802.16 radio communication standard, for example WiMax fixed or WiMax mobile), WiPro, HiperMAN (High Performance Radio Metropolitan Area Network) and/or IEEE 802.16m Advanced Air Interface, a Global System for Mobile Communications (GSM) radio communication technology, a General Packet Radio Service (GPRS) radio communication technology, an Enhanced Data Rates for GSM Evolution (EDGE) radio communication technology, and/or a Third Generation Partnership Project (3GPP) radio communication technology (for example UMTS (Universal Mobile Telecommunications System), FOMA (Freedom of Multimedia Access), 3GPP LTE (Long Term Evolution), 3GPP LTE Advanced (Long Term Evolution Advanced)), CDMA2000 (Code division multiple access 2000), CDPD (Cellular Digital Packet Data), Mobitex, 3G (Third Generation), CSD (Circuit Switched Data), HSCSD (High-Speed Circuit-Switched Data), UMTS (3G) (Universal Mobile Telecommunications System (Third Generation)), W-CDMA (UMTS) (Wideband Code Division Multiple Access (Universal Mobile Telecommunications System)), HSPA (High Speed Packet Access), HSDPA (High-Speed Downlink Packet Access), HSUPA (High-Speed Uplink Packet Access), HSPA+ (High Speed Packet Access Plus), UMTS-TDD (Universal Mobile Telecommunications System—Time-Division Duplex), TD-CDMA (Time Division—Code Division Multiple Access), TD-SCDMA (Time Division—Synchronous Code Division Multiple Access), 3GPP Rel. 8 (Pre-4G) (3rd Generation Partnership Project Release 8 (Pre-4th Generation)), UTRA (UMTS Terrestrial Radio Access), E-UTRA (Evolved UMTS Terrestrial Radio Access), LTE Advanced (4G) (Long Term Evolution Advanced (4th Generation)), cdmaOne (2G), CDMA2000 (3G) (Code division multiple access 2000 (Third generation)), EV-DO (Evolution-Data Optimized or Evolution-Data Only), AMPS (1G) (Advanced Mobile Phone System (1st Generation)), TACS/ETACS (Total Access Communication System/Extended Total Access Communication System), D-AMPS (2G) (Digital AMPS (2nd Generation)), PTT (Push-to-talk), MTS (Mobile Telephone System), IMTS (Improved Mobile Telephone System), AMTS (Advanced Mobile Telephone System), OLT (Norwegian for Offentlig Landmobil Telefoni, Public Land Mobile Telephony), MTD (Swedish abbreviation for Mobiltelefonisystem D, or Mobile telephony system D), Autotel/PALM (Public Automated Land Mobile), ARP (Finnish for Autoradiopuhelin, “car radio phone”), NMT (Nordic Mobile Telephony), Hicap (High capacity version of NTT (Nippon Telegraph and Telephone)), DataTAC, iDEN (Integrated Digital Enhanced Network), PDC (Personal Digital Cellular), PHS (Personal Handy-phone System), WiDEN (Wideband Integrated Digital Enhanced Network), iBurst, Unlicensed Mobile Access (UMA, also referred to as 3GPP Generic Access Network, or GAN standard).

Without a centralized “Communication Resources Distribution Entity”, it may be possible that mobile devices themselves identify shared spectrum configurations. However, this may lead to a non-homogeneous way of dealing with the problem and the overall behavior of concerned mobile devices may vary greatly. This may not lead to an improvement.

While the invention has been particularly shown and described with reference to specific aspects of this disclosure, it should be understood by those skilled in the art that various changes in form and detail may be made therein without departing from the spirit and scope of the invention as defined by the appended claims. The scope of the invention is thus indicated by the appended claims and all changes which come within the meaning and range of equivalency of the claims are therefore intended to be embraced.

What is claimed is:

1. A radio resource distribution device comprising:
a communication condition determination circuit configured to determine a condition under which a radio communication device is to perform communication with a radio communication network;
an availability determination circuit configured to determine at least one available radio resource out of a plurality of radio resources, that is available for the communication; and
a radio resource determination circuit configured to determine a radio resource for the communication out of the at least one available radio resource based on the determined condition;
wherein the plurality of radio resources comprises:
at least one first radio resource assigned to an operator of the radio communication network; and
at least one second radio resource assigned to a holder of the second radio resource, and assigned by the holder of the second radio resource to the operator of the radio communication network.

2. The radio resource distribution device of claim 1,
wherein the plurality of radio resources comprises:
a radio resource of a macro base station on the first radio resource;
a radio resource of a macro base station on the second radio resource;
a radio resource of a small base station on the first radio resource; and
a radio resource of a small base station on the second radio resource.

3. The radio resource distribution device of claim 1,
the condition determination circuit further configured to determine the condition based on at least one selected from a list consisting of:
a velocity of the radio communication device;
a network mobility activity of the device experienced in the recent past;
a desired quality of service of the communication;
a desired bandwidth of the communication;
a subscriber plan for the radio communication device; and
at least one communication capability of the radio communication device.

4. The radio resource distribution device of claim 1,
the availability determination circuit further configured to determine the radio resource based on at least one selected from a list consisting of:
a location of the radio communication device;
a network load;
a communication load on at least one of the plurality of radio resources;
a communication load on the radio resources of the macro base stations;
a communication quality characteristic of at least one of the plurality of radio resources; and
a subscriber plan for the radio communication device.

5. The radio resource distribution device of claim 1,
wherein the at least one first radio resource comprises a radio resource used only by the operator of the communication network.

6. The radio resource distribution device of claim 1,
wherein the at least one second radio resource comprises a radio resource shared by the operator of the communication network and the holder of the radio resource.

7. The radio resource distribution device of claim 1, further comprising:
a condition change determination circuit configured to determine whether the condition changes during an ongoing communication;
the radio resource determination circuit further configured to determine whether to change the radio resource for the communication based on whether the condition changes.

8. The radio resource distribution device of claim 1, further comprising:
a radio resource assignment circuit configured to transmit an indication of the radio resource for the communication to at least one of the radio communication device and to a base station configured to provide communication using the radio resource for the communication.

9. The radio resource distribution device of claim 1,
the radio resource determination circuit further configured to determine a radio resource on the at least one first radio resource if the availability determination circuit determines that both the at least one first radio resource and the at least one second radio resource are available for the communication.

10. The radio resource distribution device of claim 2,
the radio resource determination circuit further configured to determine a radio resource of a small base station if the radio communication device is in a condition of at least one of low velocity or low network mobility activity.

11. The radio resource distribution device of claim 1,
the radio resource determination circuit further configured to determine a plurality of radio resources for combined usage for the communication.

12. A method for controlling a radio resource distribution device, the method comprising:
determining a condition under which a radio communication device is to perform communication with a radio communication network;
determining at least one available radio resource out of a plurality of radio resources that is available for the communication; and
determining a radio resource for the communication from the at least one available radio resource based on the determined condition;
wherein the plurality of radio resources comprises:
at least one first radio resource assigned to an operator of the radio communication network; and
at least one second radio resource assigned to a holder of the second radio resource, and assigned by the holder of the second radio resources to the operator of the radio communication network.

13. The method of claim 12,
wherein the plurality of radio resources comprises:
a radio resource of a macro base station on the first radio resource;
a radio resource of a macro base station on the second radio resource;
a radio resource of a small base station on the first radio resource; and
a radio resource of a small base station on the second radio resource.

14. The method of claim 12, further comprising:
determining the condition based on at least one selected from a list consisting of:
a velocity of the radio communication device;
a network mobility activity of the device experienced in the recent past;
a desired quality of service of the communication;
a desired bandwidth of the communication;
a subscriber plan for the radio communication device; and
at least one communication capability of the radio communication device.

15. The method of claim 12, further comprising:
determining the radio resource based on at least one selected from a list consisting of:
a location of the radio communication device;
a network load;
a communication load on at least one of the plurality of radio resources;
a communication load on the radio resources of the macro base stations;
a communication quality characteristic of at least one of the plurality of radio resources; and
a subscriber plan for the radio communication device.

16. The method of claim 12,
wherein the first radio resources comprise a radio resource used only by the operator of the communication network.

17. The method of claim 12,
wherein the second radio resources comprise a radio resource shared by the operator of the communication network and the holder of the radio resource.

18. The method of claim 12, further comprising:
determining whether the condition changes during an ongoing communication; and
determining whether to change the radio resource for the communication based on whether the condition changes.

19. The method claim 12, further comprising:
transmitting an indication of the radio resource for the communication to at least one of the radio communication device and to a base station configured to provide communication using the radio resource for the communication.

20. The method of claim 12, further comprising:
determining a radio resource on the at least one first radio resource if the availability determination circuit determines that both the at least one first radio resource and the at least one second radio resource are available for the communication.

21. The method of claim 12, further comprising:
determining a radio resource of a small base station if the radio communication device is in a condition of at least one of low velocity or low network mobility activity.

22. A radio resource distribution device comprising:
a radio resource determination circuit configured to determine whether a radio communication device is to communicate with a radio communication network on a first frequency band or on a second frequency band;
wherein the first frequency band is assigned to an operator of the radio communication network; and
wherein the second frequency band is assigned to a holder of the second frequency band, and assigned by the holder of the second frequency band to the operator of the radio communication network.

23. The radio resource distribution device of claim 22,
the radio resource determination circuit further configured to determine whether the radio communication device is to communicate with a macro base station or a small base station.

24. A method for controlling a radio resource distribution device, the method comprising:
determining whether a radio communication device is to communicate with a radio communication network on a first frequency band or on a second frequency band;
wherein the first frequency band is assigned to an operator of the radio communication network; and
wherein the second frequency band is assigned to a holder of the second radio band, and assigned by the holder of the second radio band to the operator of the radio communication network.

25. The method of claim 24, further comprising:
determining whether the radio communication device is to communicate with a macro base station or a small base station.
